(19) United States
(12) Patent Application Publication
(10) Pub. No.: US 2016/0193756 A1
(43) Pub. Date: Jul. 7, 2016

(54) MICROSTRUCTURAL MATERIALS AND FABRICATION METHOD THEREOF

(71) Applicant: DAIKIN INDUSTRIES, LTD., Osaka (JP)

(72) Inventors: Akihiro OSHIMA, Suita (JP); Seiichi TAGAWA, Suita (JP); Masakazu WASHIO, Suita (JP); Tomoko OYAMA, Suita (JP); Tomohiro TAKAHASHI, Suita (JP); Satoshi OKUBO, Suita (JP); Akinobu KOBAYASHI, Suita (JP); Naotsugu NAGASAWA, Suita (JP); Mitsumasa TAGUCHI, Suita (JP)

(73) Assignee: DAIKIN INDUSTRIES, LTD., Osaka (JP)

(21) Appl. No.: 15/072,640

(22) Filed: Mar. 17, 2016

Related U.S. Application Data
(62) Division of application No. 13/340,387, filed on Dec. 29, 2011.

(30) Foreign Application Priority Data
Mar. 10, 2011 (JP) 2011-052359

(51) Int. Cl. B29C 35/08; B29C 39/38; B29C 39/02

(52) U.S. Cl. CPC B29C 35/0866; B29C 39/026; B29C 39/38; B29C 2035/0877; B29L 2031/767

(57) ABSTRACT

There are provided a microstructural material allowing a concavo-convex pattern of a mold to be imprinted thereon by hardening a pattern formative layer through an unprecedented method, and a fabrication method thereof. A PTFE dispersion liquid is used in a pattern formative layer 2a forming an imprint section 2, thereby allowing such pattern formative layer 2a formed on a concavo-convex pattern of a mold 5 to be hardened when irradiated with an ionizing radiation. Accordingly, the fabrication method of a microstructural material 1 of the present invention employs an imprinting method allowing the pattern formative layer 2a to be hardened through an ionizing radiation R, which is completely different from a thermal imprinting and an optical imprinting. That is, the pattern formative layer 2a can be hardened, and the concavo-convex pattern of the mold 5 can thus be imprinted thereon, through an unprecedented method.

### CROSS-REFERENCE TO RELATED APPLICATIONS

This application is a Divisional of U.S. application Ser. No. 13/340,387 filed Dec. 29, 2011. This application also claims priority to Japanese Application No. 2011-052359 filed Mar. 10, 2011. All of the applications above are incorporated herein by reference.

### BACKGROUND OF THE INVENTION

1. Field of the Invention

The present invention relates to a microstructural material and a fabrication method thereof.

2. Description of Related Art

In recent years, as a microfabrication technique in nanoorder scale, there has been known a method for fabricating a microstructural material through an imprinting method. Here, the imprinting method refers to a method in which a mold with a fine concavo-convex pattern formed on a surface thereof is employed, and a workpiece is hardened while being in contact with such concavo-convex pattern, followed by removing the workpiece from the mold so as to obtain a microstructural material with the concavo-convex pattern of the mold imprinted thereon (e.g., Japanese Unexamined Patent Application Publication No. 2000-194142).

As such a kind of method for fabricating a microstructural material through the imprinting method, there have been known two kinds of methods including: a thermal method (referred to as a thermal imprinting hereunder) in which a heat is used to imprint a concavo-convex pattern of a mold on a workpiece; and an optical method (referred to as an optical imprinting hereunder) in which a light (UV) is used to imprint a concavo-convex pattern of a mold on a workpiece. According to the thermal imprinting, a thermoplastic resin is used as a workpiece. A pattern formative layer is then formed by pressing the concavo-convex pattern of the mold against a heated and melted thermoplastic resin, followed by cooling such pattern formative layer as it is so as to harden the corresponding pattern formative layer made of the thermoplastic resin, thus obtaining a microstructural material with the concavo-convex pattern of the mold imprinted thereon.

Meanwhile, the optical imprinting employs: a transparent mold formed by leaving a concavo-convex pattern on a surface of a quartz substrate; and a light curing resin as a workpiece. A pattern formative layer is then formed by deforming the light curing resin of a low viscosity with the aforementioned mold, followed by irradiating such light curing resin as it is with an ultraviolet light, thereby hardening the pattern formative layer made of the light curing resin, thus obtaining a microstructural material with the concavo-convex pattern of the mold imprinted thereon.

### SUMMARY OF THE INVENTION

With regard to a fabrication method of a microstructural material, while the aforementioned thermal imprinting and optical imprinting allow a pattern formative layer to be hardened and a concavo-convex pattern of a mold to be imprinted thereon through heating/cooling and an optical radiation, respectively, there has been desired in recent years a new method for imprinting the concavo-convex pattern of the mold, other than the thermal imprinting and optical imprinting.

Particularly, a method for fabricating a microstructural material through the optical imprinting, requires that the pattern formative layer be irradiated with a light passing through the mold, when imprinting on the light curing resin the concavo-convex pattern of the mold. Accordingly, the mold in this case has to be made of a material capable of passing a light therethrough, such as a quartz glass, a fluorine resin or the like. For this reason, there has been desired in recent years a new imprinting method not restricted by the material of the mold.

In view of the aforementioned problem, it is an object of the present invention to provide a microstructural material allowing a concavo-convex pattern of a mold to be imprinted thereon by hardening a pattern formative layer through an unprecedented method, and a fabrication method thereof.

In order to solve the aforementioned problem, a microstructural material according to a first aspect of the present invention includes: an imprint section with a concavo-convex pattern of a mold imprinted thereon by hardening a pattern formative layer deformed by the mold, in which the imprint section is hardened by irradiating an ionizing radiation hardening material with an ionizing radiation.

Further, according to a second aspect of the present invention, the imprint section includes at least one of a cross-linked structure and a polymer that are formed by allowing either one or both of a cross-linking reaction and a polymerization reaction to take place in the ionizing radiation hardening material.

Furthermore, according to a third aspect of the present invention, the ionizing radiation hardening material includes: a polymer selected from a group consisting of polytetrafluoroethylene, poly (ε-caprolactone), polylactide, polyethylene, polypropylene, polystyrene, polycarbosilane, polysilane, polymethylmethacrylate, epoxy resin and polyimide; a modified polymer of the respective polymer; a copolymer of the respective polymer; or a mixture of at least two of the respective polymer, modified polymer and copolymer.

Furthermore, according to a fourth aspect of the present invention, the ionizing radiation is either any one of an electron beam, an X-ray, a gamma ray, a neutron ray and a high-energy ion radiation, or a mixed radiation thereof.

Furthermore, a fabrication method according to a fifth aspect of the present invention, includes: a formation step of forming a pattern formative layer containing an ionizing radiation hardening material, on a surface of a mold on which a concavo-convex pattern is formed; and an other formation step of forming a microstructural material with the concavo-convex pattern of the mold imprinted on an imprint section, such imprint section being formed by hardening the pattern formative layer through an irradiation with an ionizing radiation.

Furthermore, according to a sixth aspect of the present invention, the other formation step allows at least one of a cross-linking reaction and a polymerization reaction to take place in the ionizing radiation hardening material irradiated with the ionizing radiation, thus hardening the pattern formative layer.

Furthermore, according to a seventh aspect of the present invention, the ionizing radiation hardening material includes: a polymer selected from a group consisting of polytetrafluoroethylene, poly (ε-caprolactone), polylactide, polyethylene, polypropylene, polystyrene, polycarbosilane, polysilane, polymethylmethacrylate, epoxy resin and polyimide; a modified polymer of the respective polymer; a copolymer of the respective polymer; or a mixture of at least two of the respective polymer, modified polymer and copolymer.

Furthermore, according to an eighth aspect of the present invention, the ionizing radiation is either any one of an electron beam, an X-ray, a gamma ray, a neutron ray and a high-energy ion radiation, or a mixed radiation thereof.

The present invention provides a microstructural material and a fabrication method thereof. Specifically, the present invention realizes an imprinting method allowing a pattern formative layer to be hardened through an ionizing radiation, which is completely different from a thermal imprinting and an optical imprinting. Accordingly, the pattern formative layer can be hardened through an unprecedented method, and a concavo-convex pattern of a mold can thus be imprinted thereon.

### BRIEF DESCRIPTION OF THE DRAWINGS

FIG. 1 is a schematic view showing an overall structure of a microstructural material of the present invention.

FIG. 2 is a schematic view showing an overall structure of a mold.

FIG. 3A is a schematic view showing a first step of a fabrication method of the microstructural material.

FIG. 3B is a schematic view showing a second step of the fabrication method of the microstructural material.

FIG. 3C is a schematic view showing a third step of the fabrication method of the microstructural material.

FIG. 4A is a schematic diagram describing a cross-linking reaction.

FIG. 4B is a schematic diagram describing the cross-linking reaction.

FIG. 5 is a series of chemical formulae describing a cross-linking reaction of a PTFE.

FIG. 6 is a graph showing a correlation between an energy storage and a transmission through water as an accelerating voltage is changed.

FIG. 7A is a schematic view showing a first step of a fabrication method of the mold.

FIG. 7B is a schematic view showing a second step of the fabrication method of the mold.

FIG. 7C is a schematic view showing a third step of the fabrication method of the mold.

FIG. 7D is a schematic view showing a fourth step of the fabrication method of the mold.

FIG. 7E is a schematic view showing a fifth step of the fabrication method of the mold.

FIG. 8A is a schematic diagram showing a cross-linked structure formed in an other embodiment.

FIG. 8B is a schematic diagram showing a cross-linked structure formed in the other embodiment.

FIG. 9A is a diagram showing a structural formula of polyethylene.

FIG. 9B is a diagram showing polyethylene in a radicalized state.

FIG. 9C is a diagram showing polyethylene having a cross-linked structure of an H-type.

FIG. 10A is a schematic view showing a first step of a fabrication method of a microstructural material of the other embodiment.

FIG. 10B is a schematic view showing a second step of the fabrication method of the microstructural material of the other embodiment.

FIG. 10C is a schematic view showing a third step of the fabrication method of the microstructural material of the other embodiment.

FIG. 11A is an SEM image of a mold of the embodiment.

FIG. 11B is an SEM image of a microstructural material of the embodiment.

FIG. 11C is an SEM image of a mold of the embodiment.

FIG. 11D is an SEM image of a microstructural material of the embodiment.

FIG. 11E is an SEM image of a mold of the embodiment.

FIG. 11F is an SEM image of a microstructural material of the embodiment.

FIG. 11G is an SEM image of a mold of the embodiment.

FIG. 11H is an SEM image of a microstructural material of the embodiment.

FIG. 12A is an SEM image of a mold of the other embodiment.

FIG. 12B is an SEM image of a microstructural material of the other embodiment.

FIG. 12C is an SEM image of a mold of the other embodiment.

FIG. 12D is an SEM image of a microstructural material of the other embodiment.

FIG. 12E is an SEM image of a mold of the other embodiment.

FIG. 12F is an SEM image of a microstructural material of the other embodiment.

### DETAILED DESCRIPTION OF THE INVENTION

Embodiments of the present invention are described hereunder in detail and with reference to the accompanying drawings.

(1) Structures of Microstructural Material and Mold

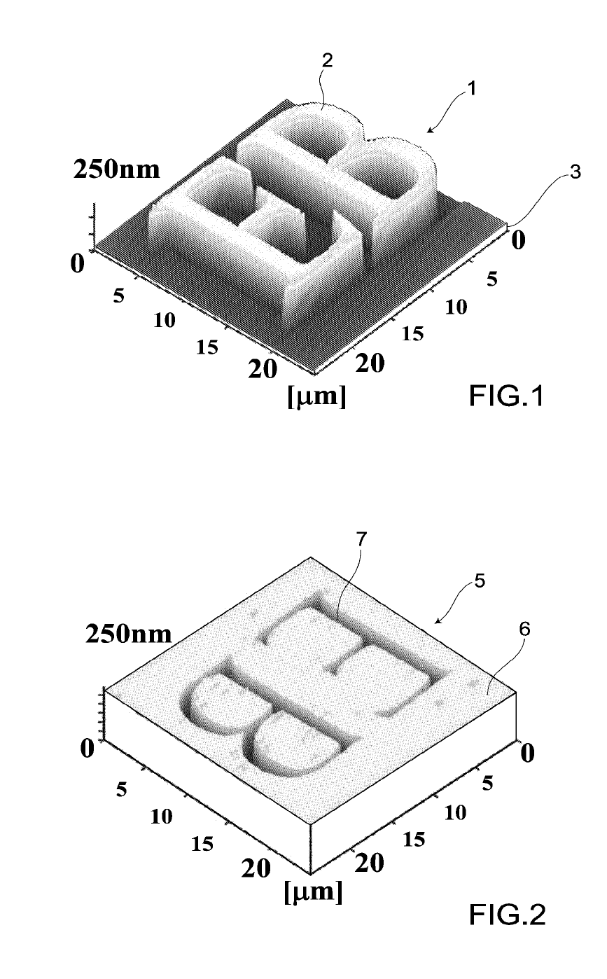

In FIG. 1, a symbol “1” represents a microstructural material of the present invention. There is formed on an imprint substrate 3 an imprint section 2 on which a concavo-convex pattern of a mold (described later) is imprinted. The imprint section 2 may, for example, be a set of fine characters such as “EB” protruding from the imprint substrate 3, having a height of 250 nm and being about 20 μm in length and width. According to the present embodiment, the imprint section 2 of the microstructural material 1 is not formed of a conventional thermoplastic resin or a light curing resin. In fact, the imprint section 2 is formed using a PTFE dispersion liquid (e.g., XAD-911 or XAD-912 by Asahi Glass Fluoropolymers) that is hardened when irradiated with an ionizing radiation such as an electron beam or the like.

The PTFE dispersion liquid serving as a composition for imprint in the present embodiment, contains polytetrafluoroethylene (which is a fluorine resin and referred to as PTFE hereunder) uniformly dispersed in an aqueous dispersion liquid such as a non-ionic surfactant or the like. The PTFE dispersion liquid is hardened when irradiated with the ionizing radiation. Particularly, a cross-linking reaction can take place as the PTFE dispersion liquid hardens, if the PTFE has already been heated and melted under an oxygen-free atmosphere at the time of irradiating the PTFE dispersion liquid with the ionizing radiation.

According to a fabrication process of the micro structural material 1, the PTFE dispersion liquid is uniformly casted, through spin coating, on a surface of the mold having the concavo-convex pattern. The PTFE dispersion liquid thus casted is then irradiated with the ionizing radiation under the oxygen-free atmosphere, with the PTFE having been heated and melted thereunder. In this way, the cross-linking reaction takes place in the PTFE, thus allowing the PTFE to be directly hardened and form the imprint section 2.

During the fabrication process of the microstructural material 1 of the present embodiment, the cross-linking reaction takes place in the PTFE, thereby allowing the microstructural material 1 to have a cross-linked structure in the imprint section 2, thus improving a mechanical strength such as a wear resistance or the like and a thermal resistance of the corresponding imprint section 2. Here, the ionizing radiation may be either any one of the aforementioned electron beam, an X-ray, a gamma ray, a neutron ray and a high-energy ion radiation, or a mixed radiation thereof.

As the mold used to fabricate the microstructural material 1, there can actually be used various kinds of molds used in a conventional thermal or optical imprinting or in other imprinting methods. As shown in FIG. 2, a mold 5 has a substrate 6 made of, for example, silicon. Further, a groove 7 of a desired shape is formed on a surface of the substrate 6 so as to form the concavo-convex pattern thereon. According to the mold 5 of the present embodiment, the groove 7 formed into an inverted “EB” shape is formed on the surface of the substrate 6 for the purpose of imprinting the protruding characters “EB” on the imprint section 2 of the microstructural material 1 (FIG. 1). The microstructural material 1 of the present invention is fabricated as follows, using the aforementioned mold 5.

(2) Fabrication Method of Microstructural Material

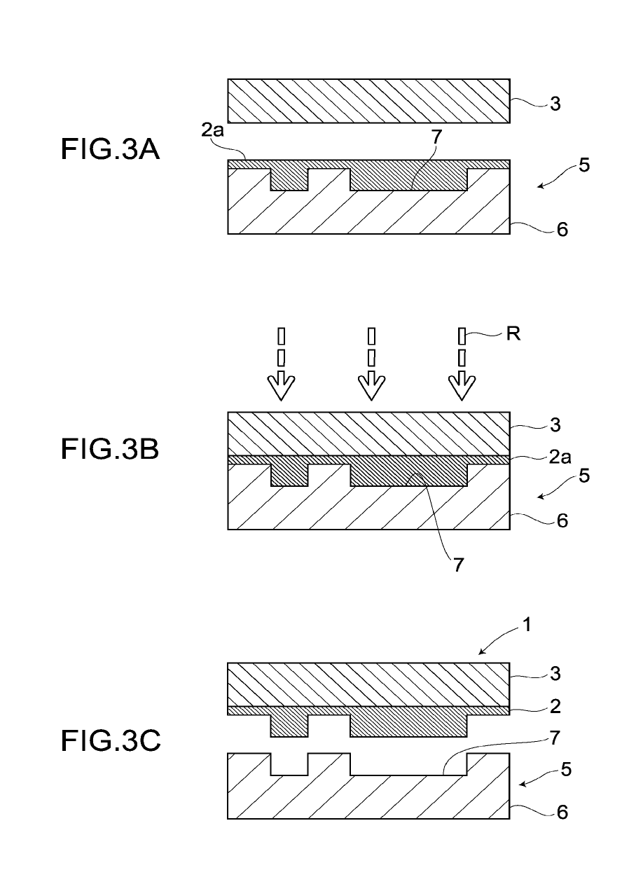

In the beginning, the PTFE dispersion liquid is applied on the concavo-convex patterned surface of the mold 5 shown in FIG. 2, followed by casting the PTFE dispersion liquid thus applied on the surface of the mold 5 through spin coating. In this way, as shown in FIG. 3A, the PTFE dispersion liquid is caused to enter the concavo-convex patterned groove 7 of the mold 5, thus allowing a pattern formative layer 2a with a uniform surface to be formed on the surface of the corresponding mold 5.

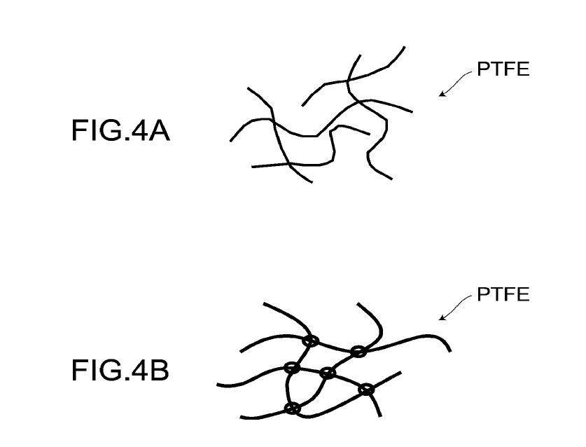

Next, the PTFE is heated and melted by heating the PTFE dispersion liquid under the oxygen-free atmosphere. As shown in FIG. 3B, an imprint substrate 3 is then pressed against the pattern formative layer 2a, followed by uniformly irradiating the corresponding formative layer 2a with an ionizing radiation R from above the imprint substrate 3, such imprint substrate 3 being made of a ceramic such as silicon, alumina, glass or the like, or a metal such as nickel or the like. In this way, the ionizing radiation R is allowed to reach the pattern formative layer 2a through the imprint substrate 3, and the entire pattern formative layer 2a can thus be irradiated. The cross-linking reaction takes place in the PTFE as the pattern formative layer 2a is irradiated with the ionizing radiation R. As a result, a straight-chain PTFE shown in FIG. 4A forms a network shown in FIG. 4B so that the pattern formative layer 2a can directly be hardened and adhere to the imprint substrate 3 so as to form the imprint section 2.

Here, other than a vacuum atmosphere, the oxygen-free atmosphere under which the pattern formative layer 2a is irradiated with the ionizing radiation R, also includes an atmosphere composed of an inert gas such as helium, nitrogen or the like. The PTFE is actually heated and melted under such a kind of atmosphere, and allows the cross-linking reaction to take place therein when irradiated with the ionizing radiation R. An other fabrication method allows the cross-linking reaction to take place in the PTFE even in the atmosphere, by increasing an absorbed dose of the ionizing radiation so as to restrict an oxidative degradation of the PTFE.

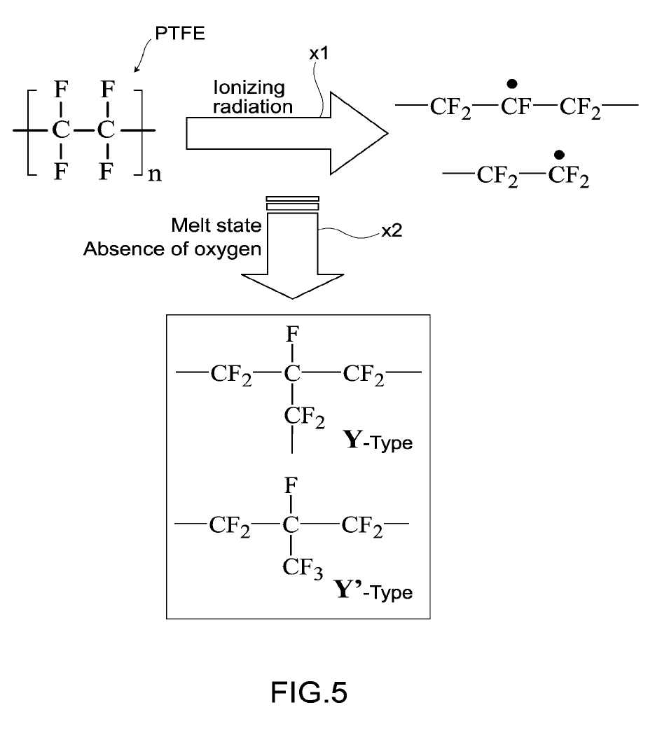

In fact, according to the present embodiment, the PTFE is used as an ionizing radiation hardening material. Particularly, as shown in FIG. 5, the PTFE is composed of fluorine (F) and carbon (C). When simply irradiated with the ionizing radiation R, main carbon chains in the PTFE are broken, thus forming carbon radicals and causing the corresponding PTFE to degrade (FIG. 5, an arrow X1 pointing to the right). In contrast, if the PTFE is irradiated with the ionizing radiation under the oxygen-free atmosphere (absence of oxygen) while being heated and melted (FIG. 5, an arrow X2 pointing downward), radicalized carbon atoms are caused to be chemically bound to one another through the cross-linking reaction, thereby forming cross-linked structures of, for example, a Y-type and a Y′-type (differing from the Y-type in the number of fluorine atoms), thus allowing a network structure to be formed in the imprint section 2.

According to the present embodiment, a highly efficient cross-linking treatment is possible, if the PTFE dispersion liquid melted at a temperature of 340 to 350° C. is then irradiated with the ionizing radiation at a temperature of a supercooled state of 310 to 325° C. It is preferred that when the PTFE dispersion liquid is irradiated with the electron beam which is an ionizing radiation, the absorbed dose thereof is 100 kGy to 1 MGy. Particularly, the absorbed dose is preferably 100 to 300 kGy if desiring to improve the wear resistance. Further, the absorbed dose is preferably not less than 500 kGy if desiring to improve the thermal resistance. Furthermore, the imprint section 2 containing PTFE can have a thermal creep property thereof at 200° C. improved significantly. Since the conventional thermoplastic resin and light curing resin used in the imprint section undergo a .beta.-transition, permittivities thereof variably change as the temperature changes. However, a dielectric property of the imprint section 2 containing PTFE stabilizes in a temperature range of −70 to 100° C.

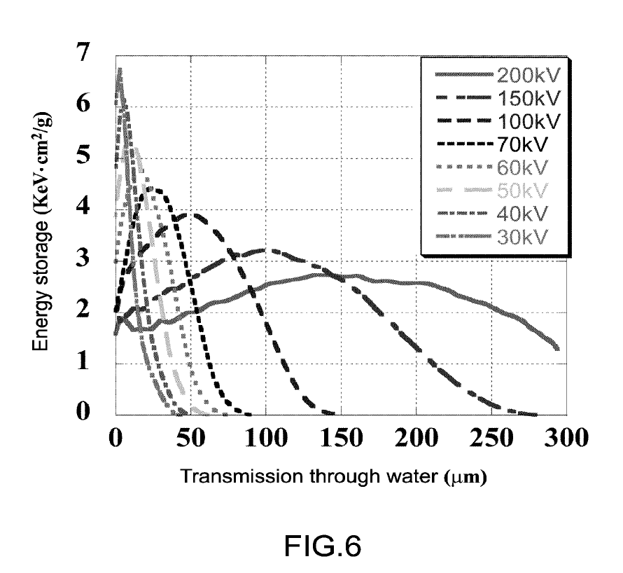

FIG. 6 is a graph showing a correlation between an energy storage and a transmission through water under a certain accelerating voltage at which the electron beam serving as an ionizing radiation is delivered, such accelerating voltage being voluntarily changed within a range of 30 to 200 kV. The graph indicates that the accelerating voltage of the electron beam can be adjusted depending on a film thickness of the pattern formative layer 2a, during the fabrication process of the microstructural material 1. For example, the graph shows that the entire pattern formative layer 2a having a film thickness of about 100 μm can be irradiated when the accelerating voltage of the electron beam is not lower than 100 kV.

As for a temperature control at the time of delivering the ionizing radiation while performing heating, there can also be used a direct heat source other than an indirect heat source such as a normal thermostatic chamber of a gas circulation type, an infrared heater, a panel heater or the like. As such heat source, there can also be directly used a heat generated at the time of controlling an energy of the electron beam emitted from an electron accelerator.

In this way, according to the aforementioned fabrication method, there can be formed on the surface of the mold 5 the microstructural material 1 having the imprint section 2 with the concavo-convex pattern imprinted thereon. Finally, as shown in FIG. 3C, there can be obtained only the microstructural material 1 having the imprint section 2 with the concavo-convex pattern of the mold 5 imprinted thereon, by removing the corresponding microstructural material 1 from the surface of the mold 5. According to the present embodiment, since the imprint section 2 contains the PTFE superior in a demoldability, it can be easily removed from the surface of the mold 5 without using a mold releasing agent that has been used conventionally in the fabrication process.

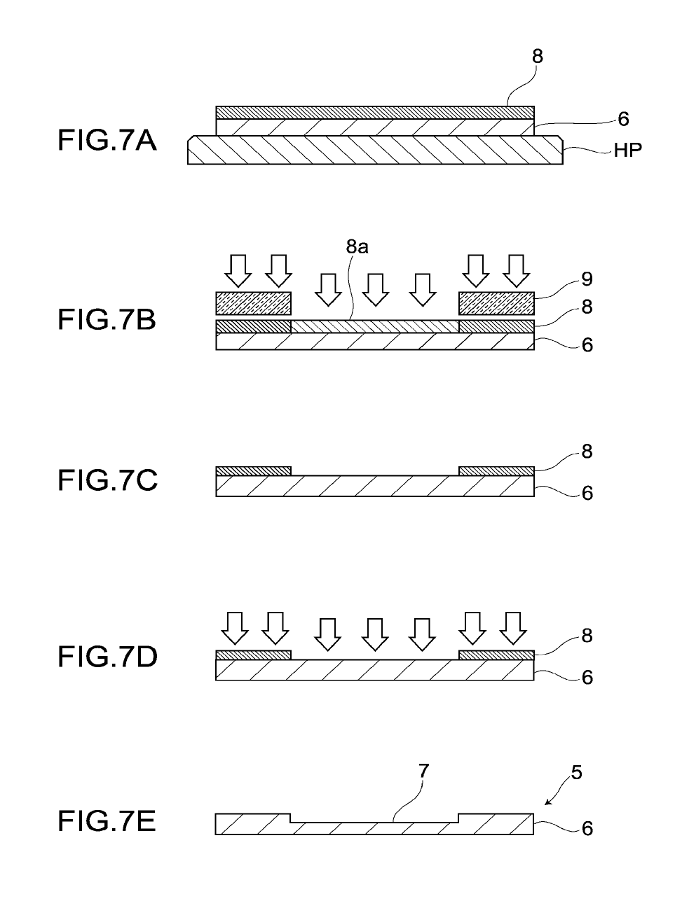

While there can be used various kinds of conventional molds in the aforementioned fabrication method, the mold 5 fabricated as follows can, for example, be used to fabricate the microstructural material 1. Specifically, a substrate 6 with a resist material applied thereon is at first placed on a hot plate HP. Next, as shown in FIG. 7A, the substrate 6 is heated by the hot plate HP, thereby forming on the substrate 6 a resist 8 with a solvent of the resist material volatilized. Next, as shown in FIG. 7B, a mask 9 opened in a given pattern is formed on the resist 8 so as to expose the corresponding resist 8 and pattern the same. The mask 9 is removed later upon completion of the patterning of the resist 8.

Subsequently, a given solution is used to etch the resist 8 so as to remove an exposed resist section 8a therefrom and eventually form, as shown in FIG. 7C, the resist 8 into a given shape exposing the substrate 6 in a given pattern. As shown in FIG. 7D, such resist 8 is then used as a mask to dry-etch the substrate 6. The resist 8 used as a mask is removed in the end so that there can be obtained, as shown in FIG. 7E, the mold 5 with the concavo-convex patterned groove 7 formed on a surface of the substrate 6. The microstructural material 1 of the present invention can be fabricated using the mold 5 thus obtained.

(3) Operation and Effect

According to the aforementioned fabrication method of the microstructural material 1 of the present invention, the PTFE dispersion liquid is used in the pattern formative layer 2a composing the imprint section 2. Therefore, such pattern formative layer 2a formed on the concavo-convex pattern of the mold 5, hardens when irradiated with the ionizing radiation, thus obtaining the microstructural material 1 having the imprint section 2 with the concavo-convex pattern of the mold 5 imprinted thereon.

In this way, the imprinting method of the present invention allows the pattern formative layer 2a to harden through the ionizing radiation, which is completely different from a thermal imprinting and an optical imprinting. That is, an unprecedented method is used to harden the pattern formative layer 2a and imprint thereon the concavo-convex pattern of the mold 5.

Further, the pattern formative layer 2a of the present embodiment contains the PTFE. Therefore, the cross-linked structure can be formed due to the cross-linking reaction taking place in the PTFE irradiated with the ionizing radiation under the oxygen-free atmosphere while being heated and melted. Accordingly, with regard to the imprint section 2, there can be improved a mechanical strength such as the wear resistance or the like, and a physical property such as the thermal resistance or the like. That is, during the fabrication process of the microstructural material 1, the cross-linked structure can be formed in the imprint section 2 without using a cross-linking agent, thereby avoiding an impurity such as the cross-linking agent itself or the like in the pattern formative layer 2a.

Furthermore, according to the microstructural material 1 of the present embodiment, the PTFE contained in the imprint section 2 is superior in the demoldability, thereby allowing the microstructural material 1 itself to be easily removed from the surface of the mold 5 without using a parting agent in the fabrication process.

Furthermore, according to the fabrication method of the microstructural material 1, it is not required that the pattern formative layer be irradiated with a light through the mold as is the case with the optical imprinting. Therefore, the mold 5 can actually be fabricated using various kinds of opaque materials such as a black material or the like. Thus, there can still be formed the imprint section 2 on which the concavo-convex pattern of the mold is imprinted, even if the corresponding mold is made of one of the aforementioned opaque materials.

(4) Other Embodiment

However, the present invention is not limited to the present embodiment. In fact, various modified embodiments are possible within the scope of the gist of the present invention. For example, other than generating electrons through the ionizing radiation, there can also be employed a thermal electron generation effected by applying a current to a tungsten filament or the like so as to heat the corresponding filament accordingly. Further, there can also be employed a method for generating photoelectrons by irradiating copper, magnesium, cesium telluride or the like with ultraviolet, or a method for generating secondary electrons through an impact of an ion collision on a medium. As for a method for accelerating electrons, there can be employed, for example, an electrostatic acceleration effected by a Cockcroft circuit, or an RF acceleration effected by a high-frequency wave. In the present invention, the electrostatic acceleration is preferred when the irradiation is delivered at an electron range of 100 μm or less. Further, although a voltage is preferably about 40 to 100 kV under the oxygen-free atmosphere, a voltage not lower than such voltage can also be employed.

Further, according to the aforementioned embodiment, the microstructural material 1 is removed from the mold 5 so as to obtain the microstructural material 1 alone and allow the corresponding microstructural material 1 to be used in various technical fields. However, the present invention is not limited to such embodiment. In fact, the microstructural material 1 coupled together with the mold 5 can be used as it is in various technical fields, without necessarily removing the microstructural material 1 from the mold 5.

Furthermore, according to the aforementioned embodiment, the PTFE dispersion liquid that is in a liquid state and contains the PTFE is used as a composition for imprint. However, the present invention is not limited to such embodiment. In fact, there can be employed a composition for imprint in various other states, such as a one that is in a gel state and contains the PTFE, as long as the concavo-convex pattern can be formed by means of the mold 5.

Furthermore, according to the aforementioned embodiment, there is employed the PTFE. Such PTFE is irradiated with the ionizing radiation under the oxygen-free atmosphere while being heated and melted, thereby causing the cross-linking reaction to take place, and thus forming the cross-linked structure. However, the present invention is not limited to such embodiment. As for an ionizing radiation hardening material, there can also be employed various kinds of materials such as a material forming a polymer through a polymerization reaction when irradiated with the ionizing radiation, or a material forming both the cross-linked structure and the polymer through both the cross-linking reaction and the polymerization reaction when irradiated with the ionizing radiation.

Furthermore, as for an ionizing radiation hardening material, there can also be employed a material undergoing only one of or neither one of the cross-linking reaction and the polymerization reaction, as long as the pattern formative layer can be hardened when irradiated with the ionizing radiation. For example, when a radiation degradable polycarbonate is employed as an ionizing radiation hardening material, the pattern formative layer containing the corresponding polycarbonate is heated up to a temperature of about 150° C. which is not lower than a glass-transition point, and is also irradiated with an ionizing radiation of 2 to 20 kGy in an oxygen-free condition. In this way, the pattern formative layer, though undergoing no cross-linking reaction, can be hardened (with a Vickers hardness being 1.5 to 2 times larger than an initial value), thus making it possible to form the imprint section.

Furthermore, according to the aforementioned embodiment, the PTFE is employed as an ionizing radiation hardening material. However, the present invention is not limited to such embodiment. As an ionizing radiation hardening material, there can also be employed materials having polymerizable functional groups and unsaturated bonds. Such materials include: a resin such a styrene-based resin, a vinyl-based resin, a vinylidene-based resin, a urethane-based resin, an acrylic-based resin, an epoxy resin or the like; and a monomer, a dimer or an oligomer that is styrene-based, vinyl-based, vinylidene-based, urethane-based, acrylic-based or epoxy-based. Specifically, an ionizing radiation hardening material can include: a polymer selected from a group consisting of poly (ε-caprolactone) [PCL], polylactide, polyethylene, polypropylene, polystyrene, polycarbosilane, polysilane, polymethylmethacrylate, epoxy resin and polyimide; a modified polymer of the respective polymer; a copolymer of the respective polymer; or a mixture of at least two of the respective polymer, modified polymer and copolymer. There is specifically described hereunder about how PCL and polylactide can be employed as ionizing radiation hardening materials.

(4-1) Ionizing Radiation Hardening Material

(4-1-1) When Poly (ε-Caprolactone) [PCL] is Employed as an Ionizing Radiation Hardening Material

A pattern formative layer containing PCL is hardened when irradiated with the ionizing radiation, thus making it possible to form the imprint section on which the concavo-convex pattern of the mold 5 is imprinted. Further, since PCL is radiation-crosslinkable, the cross-linking reaction takes place therein when irradiated with the ionizing radiation, thereby allowing the physical properties of the imprint section to be improved. As a biodegradable plastic that is also radiation-crosslinkable, there can also be employed, for example, polybutylene succinate, a copolymer of poly (butylene succinate-co-adipate) or a copolymer of poly (butylene terephthalate-co-adipate), other than PCL.

Specifically, the cross-linking reaction takes place in PCL when the pattern formative layer is irradiated with an ionizing radiation of 100 kGy or higher during the fabrication process, thereby allowing the thermal resistance of the imprint section to be improved. For example, with regard to a sample that contained PCL and had been irradiated with an ionizing radiation of 200 kGy, a thermal resistance thereof was evaluated through a high-temperature creep test. As a result, a sample that had not been irradiated with the ionizing radiation immediately broke at a melting point of 60° C. However, the sample that had been irradiated with the ionizing radiation was stable and did not break even after being held at 100° C. for 24 hours or longer. Further, the sample that had been irradiated with the ionizing radiation even tolerated a temperature of 150° C. for a short time period of about 30 minutes. Accordingly, with regard to the pattern formative layer containing PCL, the cross-linking reaction takes place when irradiated with the ionizing radiation, thus making it possible to improve the physical properties of the imprint section.

Further, by irradiating such pattern formative layer with the ionizing radiation while heating the same, the cross-linking reaction can take place in PCL and the pattern formative layer can be hardened in the same manner as when the pattern formative layer is irradiated with the ionizing radiation without being heated, even when the absorbed dose of the ionizing radiation is reduced by half. Furthermore, with regard to the imprint section in this case, a biodegradation property thereof also changes due to the cross-linking reaction taking place in PCL, and a biodegradation resistance of the corresponding imprint section, though depending on a condition, can be improved by about 1.5 to 2 times.

(4-1-2) When Polylactide is Employed as an Ionizing Radiation Hardening Material

Even a pattern formative layer containing polylactide as an ionizing radiation hardening material, can be hardened when irradiated with the ionizing radiation, thus making it possible to form the imprint section on which the concavo-convex pattern of the mold 5 is imprinted. However, since polylactide is radiation degradable, there has to be added thereto, for example, triaryl isocyanurate (TAIC), glutaric acid divinyl (GDV) or adipic acid divinyl (ADV), as a cross-linking agent, thereby allowing even the cross-linking reaction to take place therein when irradiated with the ionizing radiation, thus making it possible to form the imprint section with modified physical properties.

In this case, the absorbed dose of the ionizing radiation with which the pattern formative layer is irradiated, is preferably about 50 to 200 kGy, and most preferably about 80 kGy. Polylactide softens and a strength thereof decreases at about 50° C., and further undergoes thermal deformation at 100° C. However, when triaryl isocyanurate (TAIC) serving as a cross-linking agent is added to polylactide with a ratio of triaryl isocyanurate (TAIC) to polylactide of 3 to 100 so as to cause the cross-linking reaction to take place when irradiated with the ionizing radiation, polylactide does not undergo thermal deformation even at a temperature not lower than 200° C., and a thermal resistance thereof is thus improved by 100° C. or more as compared to polylactide without cross-linking agent. Particularly, with regard to the polylactide containing a cross-linking agent, spherocrystals are formed as the cross-linking agent is separated from polylactide when forming the pattern formative layer on the surface of the mold 5 through spin coating, thus leading to a radiative degradation. However, the cross-linking reaction in this case can still take place if the pattern-formative layer is irradiated with the ionizing radiation while being heated or at a large current (at a high-dose rate). Accordingly, even the pattern formative layer formed of polylactide containing a cross-linking agent, can allow the cross-linking reaction to take place when irradiated with the ionizing radiation, thus making it possible to improve the physical properties of the imprint section.

(4-2) Cross-Linking Reaction

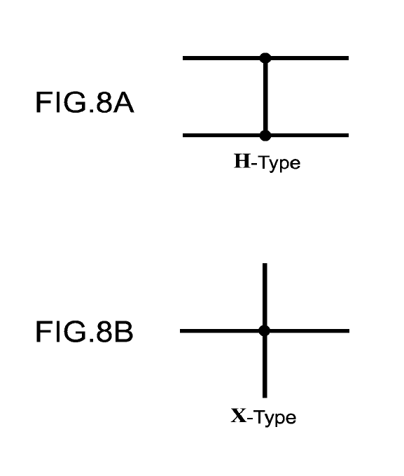

The PTFE employed in the aforementioned embodiment forms Y-shaped cross-linked structures of the Y-type and Y′-type, when irradiated with the ionizing radiation under the given condition. However, the present invention is not limited to such embodiment. In fact, there can be employed ionizing radiation hardening materials forming various other types of cross-linked structures, such as an ionizing radiation hardening material of an H-type forming an H-shaped cross-linked structure as shown in FIG. 8A, or an ionizing radiation hardening material of an X-type forming an X-shaped cross-linked structure as shown in FIG. 8B.

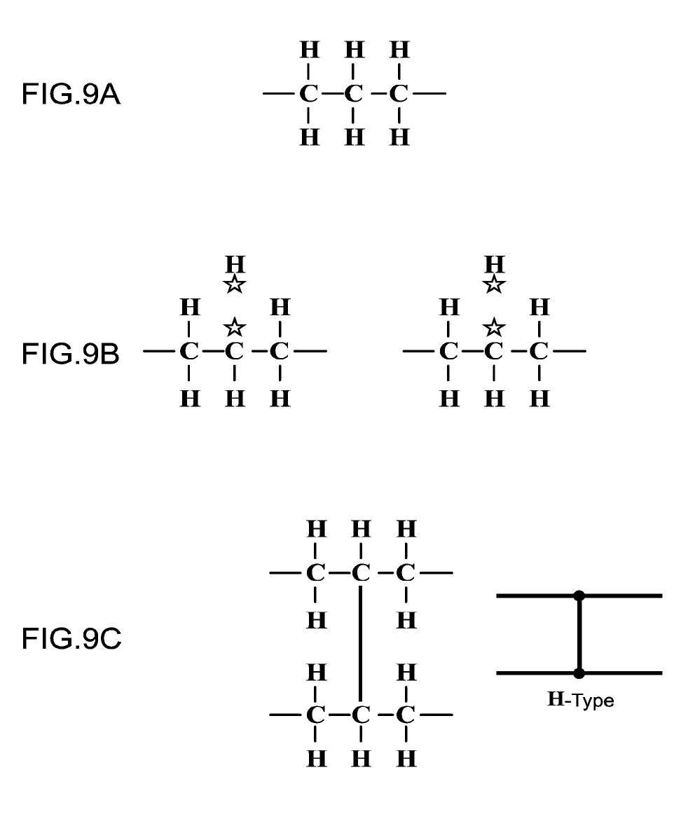

For example, when there is employed as an ionizing radiation hardening material a polyethylene composed of carbon and hydrogen as shown in FIG. 9A, carbon radicals are formed as shown in FIG. 9B at the time that the polyethylene is irradiated with the ionizing radiation. Subsequently, as shown in FIG. 9C, the radicalized carbon atoms are caused to be chemically bound to one another through the cross-linking reaction so as to form the cross-linked structure of the H-type, thus allowing the network structure to be formed in the imprint section.

(4-3) Fabrication Method of Other Embodiment

Further, according to the aforementioned embodiment and as shown in FIG. 3A through FIG. 3C, the pattern formative layer 2a is formed on the surface of the mold 5 having the concavo-convex pattern, followed by pressing the imprint substrate 3 against the pattern formative layer 2a and then irradiating the corresponding pattern formative layer 2a with the ionizing radiation, thereby allowing the pattern formative layer 2a to be hardened, and thus forming the imprint section 2. However, the present invention is not limited to such embodiment. In fact, there can be employed various other fabrication methods, as long as the imprint section 2 can be formed by irradiating the pattern formative layer 2a with the ionizing radiation R so as to harden the same.

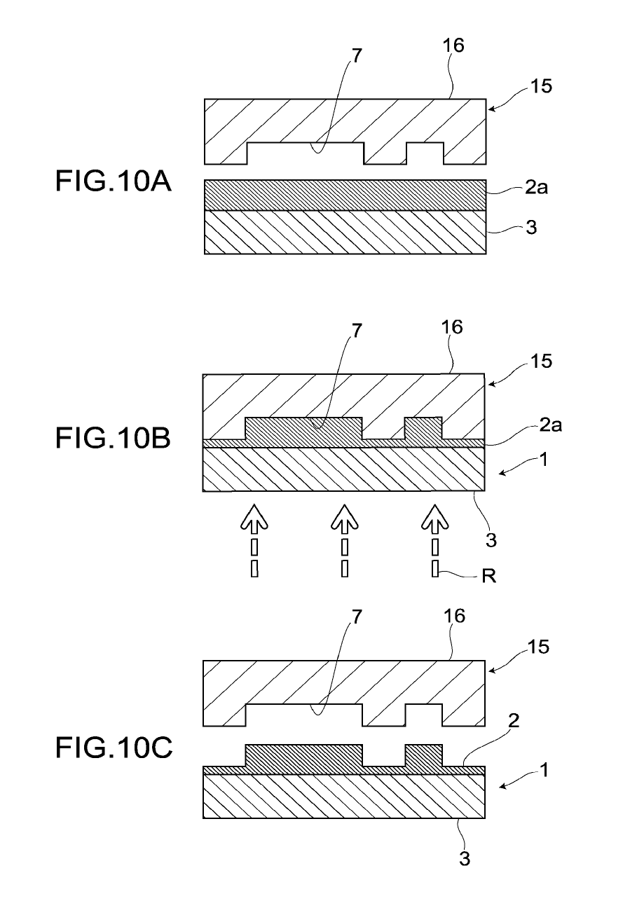

For example, the PTFE dispersion liquid containing the PTFE can be at first prepared as a composition for imprint. As shown in FIG. 10A, the PTFE dispersion liquid is then applied on the imprint substrate 3 so as to form the pattern formative layer 2a with the uniform surface. Next, as shown in FIG. 10B, there is prepared a mold 15 having a concavo-convex patterned groove 7 formed on a surface of a substrate 16. Such mold 15 is then lowered from above the pattern formative layer 2a so as to eventually allow the concavo-convex pattern of the mold 15 to press against the corresponding formative layer 2a. The pattern formative layer 2a thus pressed against by the mold 15 is then irradiated with the ionizing radiation R from a imprint substrate 1 side under the oxygen-free atmosphere, with the PTFE having been heated and melted thereunder. Accordingly, the ionizing radiation R reaches the pattern formative layer 2a through the imprint substrate 3 so that the entire pattern formative layer 2a can be irradiated therewith. The pattern formative layer 2a thus irradiated with the ionizing radiation R allows the cross-linking reaction to take place in the PTFE serving as an ionizing radiation hardening material. As a result, the straight-chain PTFE is caused to form the network so that the pattern formative layer 2a can be directly hardened and adhere to the imprint substrate 3, thus forming the imprint section 2.

In this way, there can be formed on the imprint substrate 3 the microstructural material 1 with the concavo-convex pattern imprinted on the imprint section 2. In the end, as shown in FIG. 10C, the mold 15 is removed from the microstructural material 1 so as to actually allow the microstructural material 1 to be removed from the mold 15, thus obtaining only the microstructural material 1 with the concavo-convex pattern of the mold 15 imprinted thereon.

(5) Example

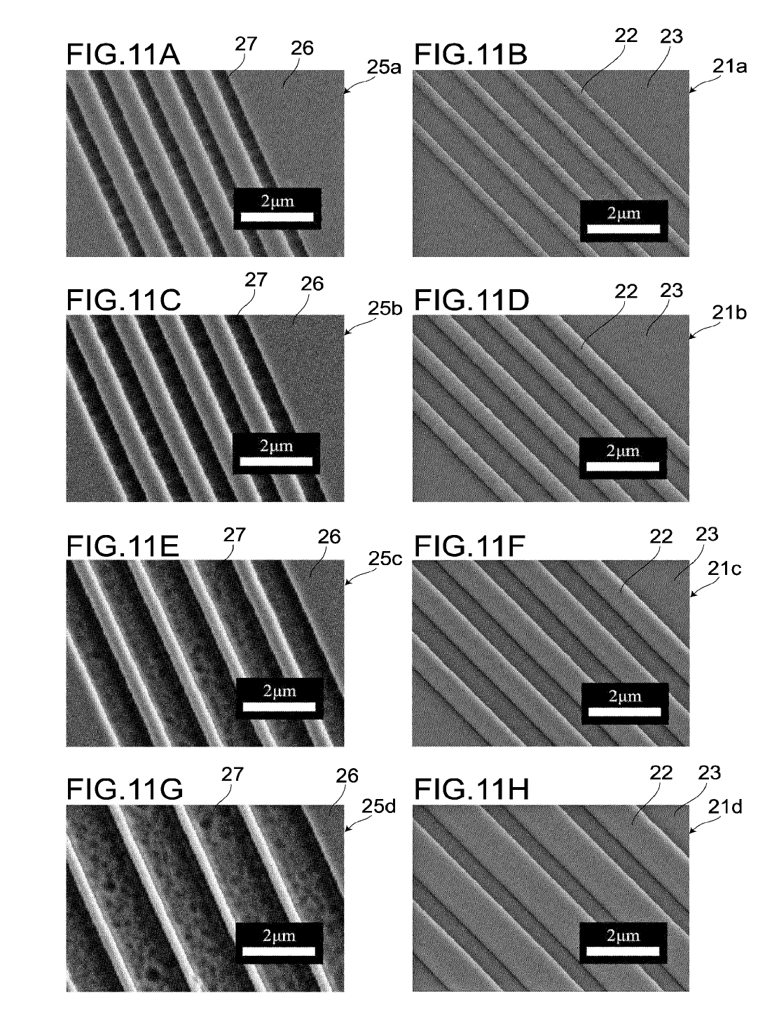

Next, as shown in FIGS. 11A, 11C, 11E and 11G, a plurality of linear grooves 27 were formed on each substrate 26. Particularly, there were prepared four kinds of molds with grooves 27 of different widths formed on the substrates 26, such molds being molds 25a, 25b, 25c and 25d and individually used to fabricate microstructural materials.

According to a fabrication method of the microstructural materials in this case, the PTFE dispersion liquid (XAD-912 by Asahi Glass Fluoropolymers) was at first applied on concavo-convex patterned surfaces of the molds 25a, 25b, 25c and 25d so as to form pattern formative layers thereon through spin coating, such concavo-convex patterned surfaces being formed by the grooves 27. The pattern formative layers were then heated at a temperature of 350° C. under a nitrogen atmosphere for 10 minutes, so as to volatilize an emulsifying agent in the PTFE dispersion liquid and melt the PTFE. Such pattern formative layers were further irradiated at a temperature of 320° C., with an electron beam at an accelerating voltage of 200 kV and an irradiation current of 1 mA. In this way, the pattern formative layers were caused to harden so as to form imprint sections, thus allowing the microstructural materials to be fabricated on the surfaces of the molds 25a, 25b, 25c and 25d.

The microstructural materials were then removed from the molds 25a, 25b, 25c and 25d, respectively, followed by observing such microstructural materials with a scanning electron microscope (SEM). As a result, there were obtained a microstructural material 21a shown in FIG. 11B, a microstructural material 21b shown in FIG. 11D, a microstructural material 21c shown in FIG. 11F and a microstructural material 21d shown in FIG. 11H, such microstructural materials 21a through 21d being fabricated using the mold 25a shown in FIG. 11A, the mold 25b shown in FIG. 11C, the mold 25c shown in FIG. 11E and the mold 25d shown in FIG. 11G, respectively.

These results indicated that, in each one of the microstructural materials 21a, 21b, 21c and 21d, there had been formed on an imprint section 23 a convex section 22 whose width matches that of the groove 27 of each one of the molds 25a, 25b, 25c and 25d, and that the fine concavo-convex patterns of the molds 25a, 25b, 25c and 25d had been precisely duplicated and imprinted on all the microstructural materials 21a, 21b, 21c and 21d.

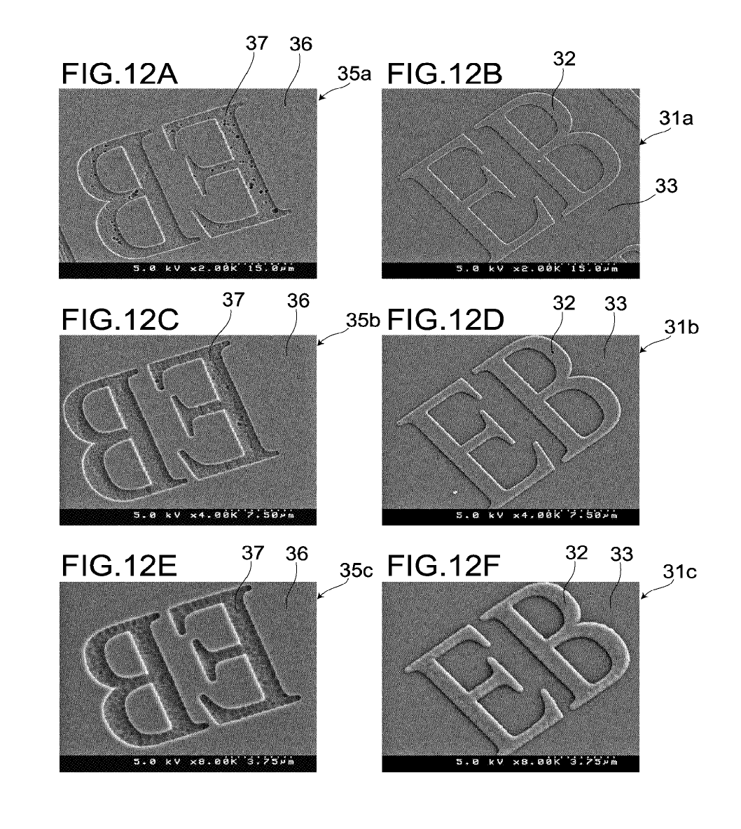

Further, as other examples and as shown in FIGS. 12A, 12C and 12E, there were formed on substrates 36 grooves 37 having the inverted “EB” shapes of different sizes. Particularly, there were prepared three kinds of molds with the character-shaped grooves 37 of different sizes formed on the substrates 36, such molds being molds 35a, 35b and 35c and individually used to fabricate microstructural materials.

In fact, a fabrication method of the microstructural materials in this case is similar to that of the aforementioned example. Specifically, the PTFE dispersion liquid identical to that used in the aforementioned example was at first applied on concavo-convex patterned surfaces of the molds 35a, 35b and 35c so as to form pattern formative layers thereon through spin coating, such concavo-convex patterned surfaces being formed by the grooves 37. The pattern formative layers were then heated at the temperature of 350° C. under the nitrogen atmosphere for 10 minutes, so as to volatilize the emulsifying agent in the PTFE dispersion liquid and melt the PTFE. Such pattern formative layers were further irradiated at the temperature of 320° C., with an electron beam at an accelerating voltage of 150 kV and the irradiation current of 1 mA.

In this way, the pattern formative layers were caused to harden so as to form imprint sections, thus allowing the microstructural materials to be fabricated on the surfaces of the molds 35a, 35b, and 35c. The microstructural materials were then removed from the molds 35a, 35b and 35c, respectively, followed by observing such microstructural materials with the scanning electron microscope. As a result, there were obtained a microstructural material 31a shown in FIG. 12B, a microstructural material 31b shown in FIG. 12D and a microstructural material 31c shown in FIG. 12F, such microstructural materials 31a, 31b and 31c being fabricated with the mold 35a shown in FIG. 12A, the mold 35b shown in FIG. 12C and the mold 35c shown in FIG. 12E, respectively. These results indicated that, in each one of the microstructural materials 31a, 31b, and 31c, there had been formed on an imprint section 33 a convex section 32 whose size matches that of the character-shaped groove 37 of each one of the molds 35a, 35b and 35c, and that the fine concavo-convex patterns of the molds 35a, 35b and 35c had been precisely duplicated and imprinted on all the microstructural materials 31a, 31b and 31c.

What is claimed:

1. A fabrication method of a microstructural material comprising:
a first formation step of forming a pattern formative layer containing an ionizing radiation hardening material containing polytetrafluoroethylene on a surface of a mold on which a concavo-convex pattern is formed; and
a second formation step of forming a microstructural material with said concavo-convex pattern of said mold imprinted on an imprint section, said imprint section being formed by hardening said pattern formative layer through an irradiation with an ionizing radiation under an oxygen-free atmosphere with said ionizing radiation hardening material being heated and melted.

2. The fabrication method of the microstructural material according to claim 1, wherein said second formation step allows at least one of a cross-linking reaction and a polymerization reaction to take place in said ionizing radiation hardening material irradiated with said ionizing radiation, thus hardening said pattern formative layer.

3. The fabrication method of the microstructural material according to claim 1, wherein said ionizing radiation hardening material contains, in addition to polytetrafluoroethylene, a polymer selected from the group consisting of poly (ε-caprolactone), polylactide, polyethylene, polypropylene, polystyrene, polycarbosilane, polysilane, polymethylmethacrylate, epoxy resin and polyimide; a modified polymer of the polymer; a copolymer of the respective polymer; or a mixture of at least two of the polymer, the modified polymer and the copolymer.

4. The fabrication method of the microstructural material according to claim 1, wherein said ionizing radiation is either any one of an electron beam, an X-ray, a gamma ray, a neutron ray and a high-energy ion radiation, or a mixed radiation thereof.

5. The fabrication method of the microstructural material according to claim 2, wherein said ionizing radiation is either any one of an electron beam, an X-ray, a gamma ray, a neutron ray and a high-energy ion radiation, or a mixed radiation thereof.

6. The fabrication method of the microstructural material according to claim 3, wherein said ionizing radiation is either any one of an electron beam, an X-ray, a gamma ray, a neutron ray and a high-energy ion radiation, or a mixed radiation thereof.

7. A fabrication method of a microstructural material comprising:
a formation step of forming an imprint section with a concavo-convex pattern of a mold imprinted thereon by hardening a pattern formative layer deformed by said mold, wherein said imprint section is hardened by irradiating an ionizing radiation hardening material containing polytetrafluoroethylene with an ionizing radiation under an oxygen-free atmosphere with said ionizing radiation hardening material being heated and melted.

8. The fabrication method of a microstructural material according to claim 7, wherein said imprint section comprises at least one of a cross-linked structure and a polymer that are formed by allowing either one or both of a cross-linking reaction and a polymerization reaction to take place in said ionizing radiation hardening material.

9. The fabrication method of a microstructural material to claim 7, wherein said ionizing radiation hardening material contains, in addition to polytetrafluoroethylene,: a polymer selected from the group consisting of poly (ε-caprolactone), polylactide, polyethylene, polypropylene, polystyrene, polycarbosilane, polysilane, polymethylmethacrylate, epoxy resin and polyimide; a modified polymer of the respective polymer; a copolymer of the polymer; or a mixture of at least two of the polymer, the modified polymer and the copolymer.

10. The fabrication method of a microstructural material according to claim 7, wherein said ionizing radiation is either any one of an electron beam, an X-ray, a gamma ray, a neutron ray and a high-energy ion radiation, or a mixed radiation thereof.
